(19) United States
(12) Patent Application Publication
(10) Pub. No.: US 2009/0077759 A1
(43) Pub. Date: Mar. 26, 2009

(54) Pool Cleaner Hoses and Methods for Making the Same

(76) Inventors: Hendrikus Johannes van der Meijden, Glen Austin (ZA); Michael Edward Moore, Johannesburg (ZA)

Correspondence Address: JOHN S. PRATT, ESQ;KILPATRICK STOCKTON, LLP, 1100 PEACHTREE STREET, ATLANTA, GA, 30309, US

(21) Appl. No.: 11/860,919

(22) Filed: Sep. 25, 2007

(51) Int. Cl. E04H 4/16; B29D 23/00

(52) U.S. Cl. 15/1.7; 264/632

(57) ABSTRACT

Some embodiments of pool cleaner hoses and methods for making the same may include a flexible hose section associated with a pool cleaner that is flexible, but also able to resist substantial compression along its longitudinal axis. In some embodiments, the flexible hose section may be formed from a number of segments.

### RELATED FIELDS

Embodiments of the present invention relate to hoses and hose sections for use with pool-cleaning systems, and methods for making the same.

### BACKGROUND

Pool-cleaning systems, such as automatic pool-cleaning systems, may include a pool cleaner in combination with a hose connecting an inlet of the pool cleaner to an inlet of a suction pump that sucks pool water from an area to be cleaned, through the inlet of the pool cleaner, through the hose, and into the inlet of the pump.

Some pool-cleaning systems include hoses, or hose sections, that are relatively flexible to allow the hose to bend such that the pool cleaner can reach tight corners in the pool, navigate around steps or other obstacles, or otherwise facilitate the pool cleaner's movement throughout the entire pool. It is also believed that flexible hoses or hose sections will be less likely to “steer” the movements of the pool cleaner, since the flexibility of the hose section may act as a buffer against steering forces that the rest of the hose might exert on the pool cleaner, potentially causing the pool cleaner to move in a direction it might not have otherwise followed. Some flexible hose sections are described in Patent Cooperation Treaty international publication number WO 2006/026553 A2, entitled “Automatic Swimming Pool Cleaners and Associated Hoses.”

In addition to allowing relatively free bending of the hose, flexible hose sections may also compress along their longitudinal axes when used with some pool cleaners. For instance, the pool cleaners disclosed in Patent Cooperation Treaty international publication number WO 2006/020835 A2 and entitled “Automatic Swimming Pool Cleaner and Components Thereof” may include a valve that, during operation, moves between open and closed positions to cyclically interrupt the flow of water through the pool cleaner and its associated hose. Such cyclical interruption may exert forces on a flexible hose section that causes it to cyclically compress and extend along its longitudinal axis. This cyclical compression and extension of the hose section may cause undesired wear or other failures in the hose section.

### SUMMARY

Some embodiments of the present invention include pool-cleaning systems with hose sections that are flexible, but also resistant to substantial compression along their longitudinal axes. Such flexible hose sections may include a rigid frame that resists being substantially compressed, but is also bendable. In some embodiments, the rigid frame includes a number of hinges that facilitate bending of the hose section. The flexible hose section may also include a flexible member, which may be overmolded onto the rigid frame.

In some embodiments, the flexible hose section is formed from a number of hose segments that are at least temporarily joined to one another. In some embodiments, structures on the hose segments may interact with one another to deter disengaging the first hose segment from the second hose segment.

Some of the embodiments of the present invention may also include methods for making pool-cleaner hose sections, such as the pool-cleaner hose sections described above.

### BRIEF DESCRIPTION OF DRAWINGS

FIG. 1 schematically illustrates a pool-cleaning system in accordance with one of the embodiments of the present invention.

FIG. 2 shows a flexible hose section in accordance with one of the embodiments of the present invention.

FIG. 3 shows another view of the flexible hose section of FIG. 2.

FIG. 4 shows another view of the flexible hose section of FIG. 2.

FIG. 5 shows the flexible hose section of FIG. 2 in a partially disassembled state.

FIG. 6 shows a close up of one of the hose segments shown in FIG. 5.

FIG. 7 shows the flexible hose section of FIG. 2 in a bent orientation.

### DETAILED DESCRIPTION OF DRAWINGS

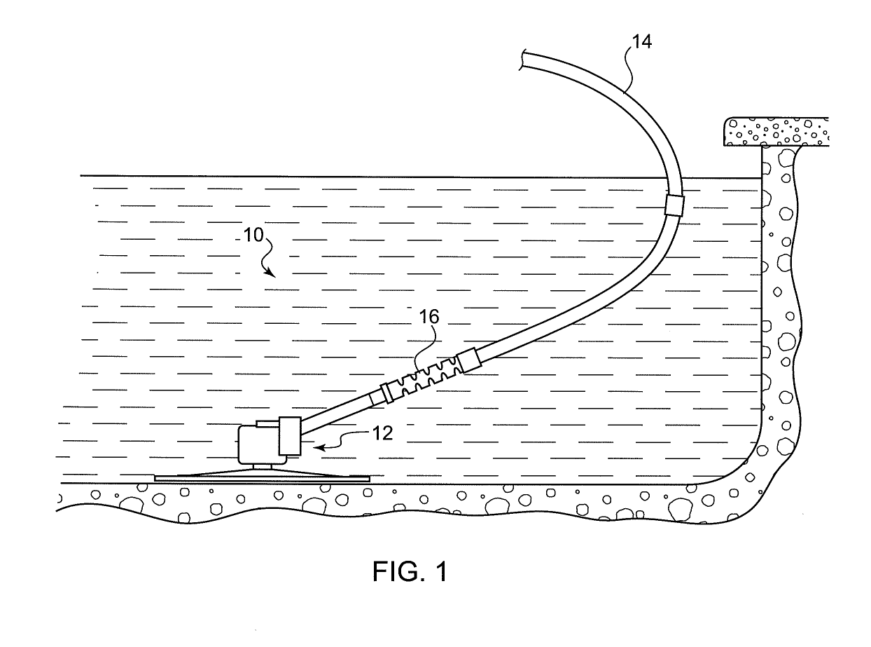

FIG. 1 shows a pool-cleaning system 10, which includes a pool cleaner 12 associated with a hose 14. The interior of hose 14 defines an aperture through which water and debris can be evacuated through pool cleaner 12.

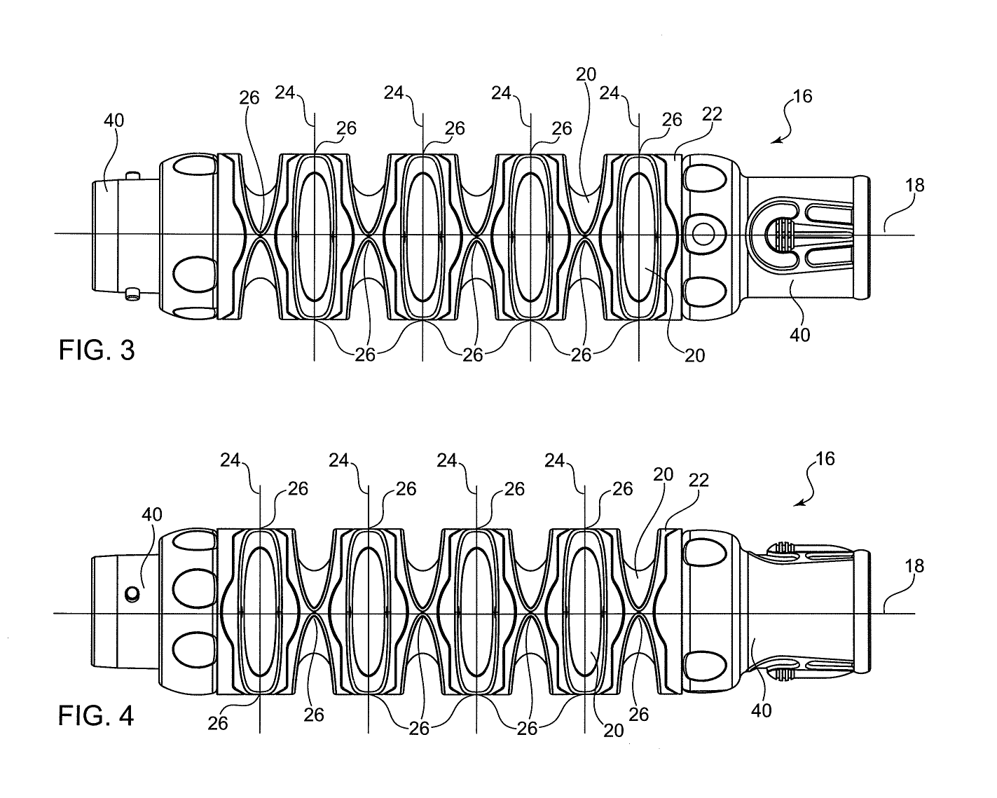

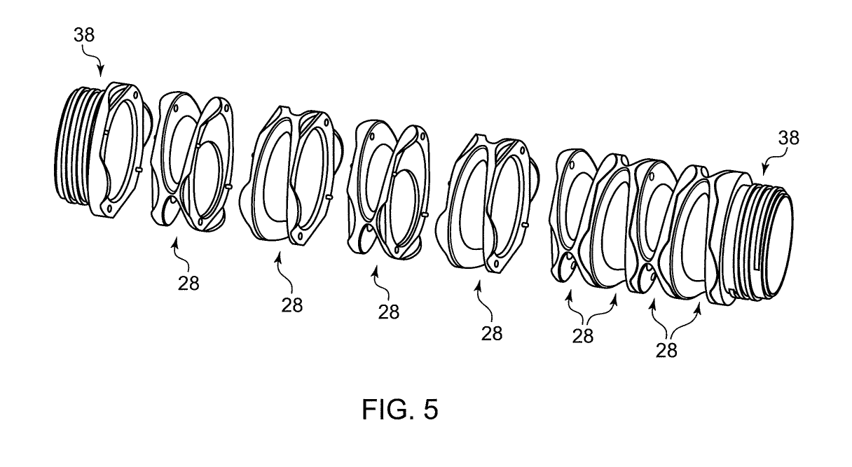

As shown in FIG. 1, hose 14 includes a flexible hose section 16. In some of the embodiments of the present invention, hose section 16 may be flexible, but also able to resist being substantially compressed along its longitudinal axis 18 (axis 18 is shown in FIGS. 3 and 4). As shown, the length of flexible hose section 16 is relatively short in relation to the length of hose 14, and could, in some embodiments, be only eight to ten inches long. In other embodiments, however, flexible hose section 16 could be shorter or longer than the hose section 16 shown in FIG. 1.

In some embodiments, there may not be an ideal length for flexible hose section 16 for all of its potential uses, and the length of flexible hose section 16 may be optimized for some uses. For example, for some uses, it may be desirable to provide a longer length of flexible hose section 16 that, in some embodiments, may have a relatively greater flexibility than shorter lengths of hose section 16. In other embodiments, less flexibility may be needed and a shorter length of hose section 16 may be all that is desired. In still other embodiments, the length of hose section 16 does not substantially impact on its degree of flexibility. Factors other than degree of flexibility may also impact on what length is selected for flexible hose section 16.

As mentioned earlier, FIG. 1 shows flexible hose section 16 as having a relatively short length in relation to the whole length of hose 14. In other embodiments, however, flexible hose section 16 may not just be a portion of hose 14, but may constitute the majority or even the entire length of hose 14. FIG. 1 shows flexible hose section 16 as a separate component connected to the rest of hose 14, although in other embodiments, flexible hose section 16 may be an integral part of hose 14.

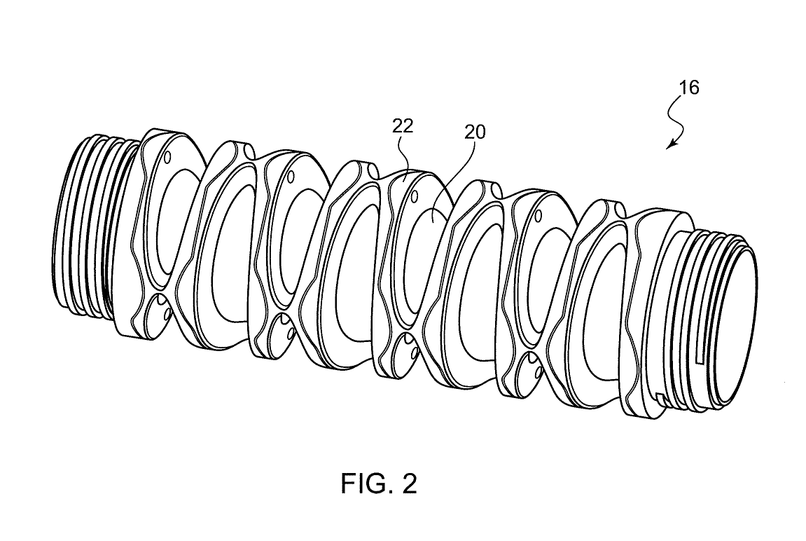

FIG. 2 shows one embodiment of a flexible hose that is primarily composed of two components: flexible member 20 and rigid frame 22. In the embodiment shown, frame 22 is formed from a relatively rigid material that resists substantial compression along the longitudinal axis 18 of hose section 16, yet still allows the hose section 16 to bend about one or more axes, as is discussed further below for some embodiments. Rigid frame 22 may be made of injection molded polypropylene, but can also be formed from other materials and in other manners.

In the embodiment shown, flexible member 20 is a flexible membrane associated with rigid frame 22 that, along with rigid frame 22, defines the aperture of hose section 16 through which water and debris can flow, but does not substantially impede any of the bending movements of rigid frame 22. Portions of flexible member 20 may have a scalloped shape that allows flexible member 20 to relatively easily collapse and extend to facilitate the bending of hose section 16, such as is shown in FIG. 7.

In some embodiments, flexible member 20 may be formed by overmolding a monoprene onto rigid frame 22. Flexible member 20 may also be formed in other manners and from other materials.

In still other embodiments, hose section 16 is not formed from two distinct components, and may be formed from only a single component or material or from more than two components or materials. Indeed, it is not necessary in all embodiments that the flexible hose sections include both a rigid component and a flexible component. Other embodiments of flexible hose sections may be formed from a single material, yet still allow the hose section to bend relatively freely while still resisting substantial compression along its longitudinal axis.

FIGS. 3 and 4 show elevation views of the flexible hose section 16 embodiment of FIG. 2 in which FIG. 4 shows the hose section 16 rotated ninety-degrees around its longitudinal axis 18 with respect to the view of hose section 16 shown in FIG. 3.

In the embodiment shown in FIGS. 3 and 4, rigid frame 22 is able to bend about hinge axes 24. As shown, the rigid frame 22 may include a number of hinges 26 to facilitate bending hose section 16 about the various hinge axes 24. As shown, hinges 26 are integral with rigid frame 22, and are living hinges. In other embodiments, however, other types of hinges, or other structures, may be provided that allow bending of flexible hose section 16.

In the embodiment shown in FIGS. 3 and 4, hinges 26 are oriented such that not all of the hinge axes 24 are parallel to one another. As shown, each hinge axis 24 is oriented at ninety-degrees to the immediately adjacent hinge axis 24 or axes 24. In other words, every other hinge axis 24 may be parallel to one another. This arrangement of hinge axes 24 may allow hose section 16 to flex and bend into a wide variety of orientations.

In other embodiments, hinge axes 24 may be oriented in other manners with respect to one another. For instance, hinge axes 24 may be oriented such that they are incremented at forty five-degrees with respect to one another, such that every fourth hinge axis 24 is parallel. In still other embodiments, none of the hinge axes 24 are parallel to one another, and the orientations of hinge axes 24 may be unimportant.

In the embodiment of FIGS. 3 and 4, hinge axes 24 generally bisect rigid frame 22, such that they are transverse to the longitudinal axis 18 of the flexible hose section 16. In other embodiments, however, the hinges 26 may be offset such that the hinge axes 24 are not transverse to the longitudinal axis 18 of hose section 16.

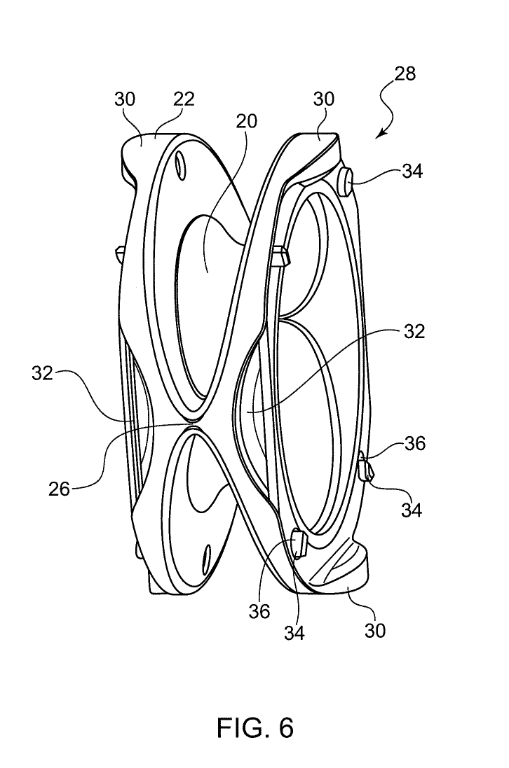

FIG. 5 shows a flexible hose section 16 that is not formed as one continuous length (although in some embodiments it may be), but is composed of a number of distinct segments 28. In some embodiments, the segmented design may make it easier to mold flexible member 20 onto rigid frame 22. For instance, in some embodiments, it may be easier to overmold flexible member 20 onto rigid frame 22 in individual segments 28, rather than molding an entire length of rigid frame 22 and then overmolding flexible member 20 onto that entire length. In these or other embodiments, the segmented design may also make it easier to increase or decrease the length of flexible hose section 16 by adding or taking away segments 28 rather than creating new molds for hose sections 16 of different lengths.

In the embodiment shown in FIG. 5, the segments 28 are identical to one another. As shown, each segment 28 includes one hinge 26 connecting identical halves of rigid frame 22, although, in some of the other embodiments, each segment 28 may include more than one hinge 26 (or even no hinge at all). In the embodiment shown, the adjacent hinge axes 24 are at ninety-degrees to one another because the adjacent segments 28 are connected to one another such that each segment 28 is rotated ninety-degrees with respect to its adjacent segment 28. In other embodiments, however, segments 28 are not necessarily all identical to one another and/or may be rotated at other than ninety-degree angles with respect to one another or not rotated at all.

FIG. 5 also shows that flexible hose section 16 may include a pair of adapters 38 at the ends of hose section 16 for coupling flexible hose section 16 to other components of pool-cleaning system 10. For instance, in some embodiments, adapters 38 may facilitate connecting flexible hose section 16 at one end to pool cleaner 12 and at its other end to the rest of hose 14. In other embodiments, flexible hose section 16 may be incorporated into a pool-cleaning system in other manners.

In the embodiment shown in FIG. 5, adapter 38 facilitates associating flexible hose section 16 with other components of pool-cleaning system 10 by securing a pair of cuffs 40 (such as the cuffs shown in FIGS. 3 and 4) to the ends of flexible hose section 16, which may in turn secure to other components of a pool-cleaning system, such as pool cleaner 12 and the rest of hose 14 shown in FIG. 1.

In the embodiment shown in FIG. 5, adapters 38 are associated with segments 28 using the same types of arms 30, grooves 32, projections 34, and indentations 36 that help to secure segments 28 to one another, as is discussed further below. As also shown in FIG. 5, adapters 38 may include external threads that interact with internal threading on cuffs 40 to secure the cuffs 40 to flexible hose section 16. In other embodiments, however, adapters 38 may be secured to segments 28, and cuffs 40 may be secured to adapters 38, in any suitable or desirable manner. In still other embodiments, adapters 38 are not necessary and cuffs 40 are directly connected to or formed integrally with flexible hose section 16. In still other embodiments, cuffs 40 are unnecessary, and flexible hose section 16 may be associated with other components of a pool-cleaning system in any suitable or desirable manner.

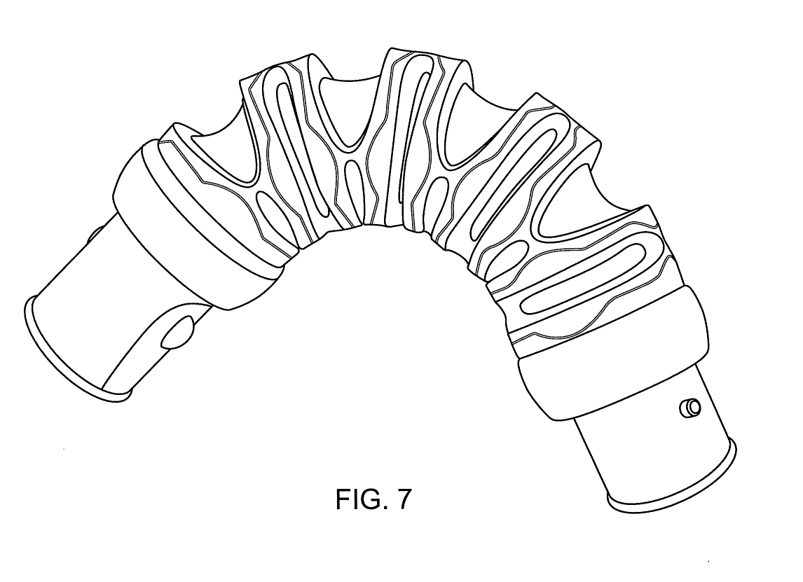

FIG. 6 shows a close up view of one embodiment of a segment 28. In the embodiment shown in FIG. 6, the portion of rigid frame 22 of segment 28 is formed to include a plurality of arms 30 and a plurality of grooves 32. Arms 30 and grooves 32 may interact with one another to at least temporarily secure the segments 28 together. In some of the embodiments, the material and/or structure of arms 30 and grooves 32 may allow them to interact in a snap-fit relationship. For instance, the material forming arms 30 and grooves 32 (which may be the same as the rest of rigid frame 22, or different) may be resilient enough such that arms 30 and/or grooves 32 will slightly bend as the arms 30 are brought into contact with the grooves 32, and then spring back once the arms 30 have fully engaged the grooves 32, securing the two segments together. In other embodiments, however, how segments 28 are secured to one another is unimportant and segments 28 may include other structure for securing them together, or may be secured together in other manners.

In the embodiment shown in FIG. 6, arms 30 and grooves 32 are positioned at approximately ninety degrees to one another around the circumference of the face of rigid frame 22, such that segments 28 will be rotated ninety degrees with respect to one another when they are connected. In other embodiments, however, arms and grooves 32 may be located on rigid frame 22 in other manners.

In some embodiments, the interaction of arms 30 with grooves 32 only temporarily secures the segments 28 together. In such embodiments, it may be possible to squeeze one of the segments 28 such that it will flex somewhat to disengage the arms 30 from their respective grooves 32 to disconnect the segments 28 from one another. In the embodiment shown in FIG. 6, however, rigid frame 22 includes projections 34 and corresponding indentations 36, which may interact with one another when the segments 28 are connected, to resist at least some efforts at flexing segments 28 to disengage arms 30 from grooves 32. In such embodiments, once segments 28 are secured to one another, it may be difficult to disconnect them.

In the embodiment shown in FIG. 6, each mating face of rigid frame 22 includes four projections 34 and four indentations 36 spaced at equal intervals around the face of rigid frame 22. As shown, each projection 34 is half of a cylinder with the indentation 36 occupying the space where the other half-cylinder corresponding to projection 34 would be. In this embodiment, the projections 34 from one mating face of a segment 28 fit into the indentations 36 from a mating face on another segment 28 when the two are secured together. This interaction of the projections 34 with the indentations 36 may at least somewhat prevent the segments 28 from becoming disconnected from one another. In other embodiments, these or other structures may be formed and positioned in other manners to help prevent the disconnection of segments 28. In still other embodiments, such additional structures are not necessary and/or the interaction of the arms 30 with grooves 32 alone may be sufficient to keep the segments 28 connected.

Flexible hose sections 16 may be formed using any suitable or desirable methodology. In some of the embodiments where flexible hose section 16 includes flexible member 20 and rigid frame 22 components, flexible hose section 16 may be formed in a two-step process. For instance, in some embodiments, flexible hose section 16 may be formed by first injection molding the rigid frame 22 and then overmolding the flexible member 20 onto the rigid frame in an overmolding process. In some embodiments, the hose section 16 is formed as individual segments 28, which are secured to one another after the flexible member 20 components have been overmolded onto the rigid frame components 22 of each segment 28. In other embodiments, other conventional or non-conventional methodologies can be used to form flexible hose sections 16.

As those skilled in the art will appreciate, the particular embodiments of this invention described above and illustrated in the figures are provided for explaining the invention, and various alterations may be made in the structure and materials of the illustrated embodiments without departing from the spirit and scope of the invention as described above.

1. A pool-cleaning system comprising:
(a) a pool cleaner; and
(b) a flexible hose section associated with the pool cleaner; the flexible hose section defining a longitudinal axis and an aperture extending along the longitudinal axis through which water can flow; wherein the flexible hose section resists substantial compression along the longitudinal axis.

2. The pool-cleaning system of claim 1, wherein the flexible hose section comprises a rigid frame that resists substantial compression of the flexible hose section along the longitudinal axis.

3. The pool-cleaning system of claim 2, wherein the flexible hose section further comprises a flexible member associated with the rigid frame.

4. The pool-cleaning system of claim 3, wherein the rigid frame comprises at least one first hinge and at least one second hinge; wherein the at least one first hinge facilitates bending of the flexible hose section around a first hinge axis; wherein the at least one second hinge facilitates bending of the flexible hose section around a second hinge axis; and wherein the first hinge axis is not parallel to the second hinge axis.

5. The pool-cleaning system of claim 4, wherein the first hinge axis and the second hinge axis are transverse to the longitudinal axis of the flexible hose section.

6. The pool-cleaning system of claim 5, wherein the rigid frame further comprises at least one third hinge and at least one fourth hinge, the at least one third hinge facilitating bending of the flexible hose section around a third hinge axis that is transverse to the longitudinal axis of the flexible hose section and substantially parallel to the first hinge axis, the at least one fourth hinge permitting bending of the flexible hose section around a fourth hinge axis that is transverse to the longitudinal axis of the flexible hose section and substantially parallel to the second hinge axis.

7. The pool-cleaning system of claim 4, wherein the flexible hose section comprises a first hose segment at least temporarily secured to a second hose segment; wherein the first hose segment comprises the at least one first hinge; and wherein the second hose segment comprises the at least one second hinge.

8. The pool-cleaning system of claim 7, wherein two or more arms extending from the first hose segment interact with two or more grooves formed in the second hose segment to facilitate at least temporarily securing the first hose segment to the second hose segment.

9. The pool-cleaning system of claim 8, wherein two or more arms extending from the second hose segment interact with two or more grooves formed in the first hose segment to facilitate at least temporarily securing the first hose segment to the second hose segment.

10. The pool-cleaning system of claim 8, wherein two or more arms extending from the second hose segment interact with two or more grooves formed in a third hose segment to facilitate at least temporarily securing the second hose segment to the third hose segment.

11. The pool-cleaning system of claim 8, wherein the two or more arms extending from the first hose segment interact with the two or more grooves formed in the second hose segment in a snap-fit relationship.

12. The pool-cleaning system of claim 11, wherein two or more projections extending from the first hose segment interact with two or more indentations on the second hose segment to at least partially deter the first hose segment from being disengaged from the second hose segment.

13. The pool-cleaning system of claim 4, wherein the at least one first hinge and the at least one second hinge comprise living hinges.

14. A pool-cleaning system, comprising:
(a) a pool cleaner; and
(b) a flexible hose section associated with the pool cleaner; the flexible hose section defining a longitudinal axis and an aperture extending along the longitudinal axis through which water can flow;
wherein the flexible hose section resists substantial compression along the longitudinal axis; and
wherein the flexible hose section comprises at least a first hose segment that is at least temporarily secured to a second hose segment.

15. The pool-cleaning system of claim 14, wherein the first and second hose segments each comprise a rigid frame and a flexible member associated with the rigid frame.

16. The pool-cleaning system of claim 15, wherein two or more arms extending from the first hose segment interact with two or more grooves formed in the second hose segment to facilitate at least temporarily securing the first hose segment to the second hose segment.

17. The pool-cleaning system of claim 16, wherein two or more arms extending from the second hose segment interact with two or more grooves formed in the first hose segment to facilitate at least temporarily securing the first hose segment to the second hose segment.

18. The pool-cleaning system of claim 16, wherein two or more arms extending from the second hose segment interact with two or more grooves formed in a third hose segment to facilitate at least temporarily securing the second hose segment to the third hose segment.

19. The pool-cleaning system of claim 16, wherein the two or more arms extending from the first hose segment interact with the two or more grooves formed in the second hose segment in a snap-fit relationship.

20. The pool-cleaning system of claim 19, wherein two or more projections extending from the first hose segment interact with two or more indentations on the second hose segment to at least partially deter the first hose segment from being disengaged from the second hose segment.

21. The pool-cleaning system of claim 16, wherein the rigid frame of the first hose segment comprises a first hinge; wherein the rigid frame of the second hose segment comprises a second hinge; wherein the first hinge permits bending of the flexible hose section around a first hinge axis; and wherein the second hinge permits bending of the flexible hose section around a second hinge axis that is not parallel with the first hinge axis.

22. The pool-cleaning system of claim 21, wherein the first hinge axis and the second hinge axis are transverse to a longitudinal axis of the flexible hose section.

23. The pool-cleaning system of claim 22, wherein the flexible hose section comprises a third hose segment and a fourth hose segment; wherein a rigid frame of the third hose segment comprises a third hinge; wherein the third hinge permits bending of the hose section around a third hinge axis that is transverse to the longitudinal axis of the flexible hose section and substantially parallel to the first hinge axis; wherein a rigid frame of the fourth hose segment comprises a fourth hinge; and wherein the fourth hinge permits bending of the flexible hose section around a fourth hinge axis that is transverse to the longitudinal axis of the flexible hose section and substantially parallel to the second hinge axis.

24. A method of making a pool-cleaner hose section, comprising:
(a) forming a first hose segment, wherein forming the first hose segment comprises:
(i) forming a first rigid frame component comprising a longitudinal axis, wherein the first rigid frame component resists substantial compression along the longitudinal axis; and
(ii) forming a first flexible member associated with the first rigid frame component;
(b) forming a second hose segment, wherein forming the second hose segment comprises:
(i) forming a second rigid frame component comprising a longitudinal axis, wherein the second rigid frame component resists substantial compression along the longitudinal axis of the second rigid frame component; and
(ii) forming a second flexible member associated with the second rigid frame component;
(c) at least temporarily securing the first hose segment to the second hose segment.

25. The method of making a pool-cleaner hose section of claim 24, wherein forming the first rigid frame component comprises forming the first rigid frame component to include a first hinge, wherein the first hinge facilitates bending of the first hose segment around a first hinge axis; and wherein forming the second rigid frame component comprises forming the second rigid frame component to include a second hinge, wherein the second hinge facilitates bending of the second hose segment around a second hinge axis, such that the first hinge axis is not parallel to the second hinge axis when the first hose segment is secured to the second hose segment.

26. The method of making a pool-cleaner hose section of claim 24, wherein securing the first hose segment to the second hose segment comprises engaging two or more arms extending from the second hose segment with two or more grooves formed in the first hose segment.

27. The method of making a pool-cleaner hose section of claim 26, wherein securing the first hose segment to the second hose segment further comprises engaging two or more arms extending from the first hose segment with two or more grooves formed in the second hose segment.

28. The method of making a pool-cleaner hose section of claim 24, further comprising securing additional hose segments to the first and second hose segments.

29. The method of making a pool-cleaner hose section of claim 24, wherein forming the first hose segment further comprises:
(a) molding the first rigid frame component; and
(b) molding the first flexible member onto the first rigid frame component.

30. The method of making a pool-cleaner hose section of claim 24, further comprising associating a cuff with an end of the first hose segment.

31. The method of making a pool-cleaner hose section of claim 30, wherein associating the cuff with the end of the first hose segment comprises securing an adapter to the first hose segment and securing the cuff to the adapter.

32. The method of making a pool-cleaner hose section of claim 31, wherein securing the adapter to the first hose segment comprises engaging two or more arms extending from the adapter with two or more grooves formed in the first hose segment.

33. A flexible hose section, comprising: a longitudinal axis; an aperture extending along the longitudinal axis through which water can flow; a rigid frame that resists substantial compression of the flexible hose section along the longitudinal axis; and a flexible member associated with the rigid frame.

34. A method of making a pool-cleaner hose section, comprising forming a hose segment, wherein forming the hose segment comprises:
(a) forming a rigid frame component comprising a longitudinal axis, wherein the first rigid frame component resists substantial compression along the longitudinal axis; and
(b) forming a flexible member associated with the first rigid frame component.
